(19) United States
(12) Patent Application Publication
(10) Pub. No.: US 2008/0233292 A1
(43) Pub. Date: Sep. 25, 2008

(54) Method for manufacturing substrate for microarray

(75) Inventors: Wataru Kusaki, Niigata (JP); Takeshi Kinsho, Niigata (JP); Toshinobu Ishihara, Niigata (JP)

Correspondence Address: OLIFF & BERRIDGE, PLC, P.O. BOX 320850, ALEXANDRIA, VA, 22320-4850, US

(73) Assignee: SHIN-ETSU CHEMICAL CO., LTD., TOKYO (JP)

(21) Appl. No.: 12/076,182

(22) Filed: Mar. 14, 2008

(30) Foreign Application Priority Data
Mar. 22, 2007 (JP) 2007-75291

(51) Int. Cl. B05D 3/00

(52) U.S. Cl. 427/331

(57) ABSTRACT

To provide a method for manufacturing a substrate for microarray which will allow, when a monomolecular film with silicon oxide chains formed on a substrate is used for the immobilization of a target molecule, a chemically amplified type resist film to be directly applied onto the substrate so as to simplify the process and enable fine processing, without causing therewith any problems such as the degradation of resolution and detachment, through more simplified procedures than are possible with the conventional method.

The method for manufacturing a substrate for microarray comprises at least the steps of: forming a monomolecular film on the surface of a substrate using a silane compound represented by the following general formula (1),

Y₃Si—(CH₂)ₘ—X, (1)
wherein m represents an integer from 3 to 20; X a hydroxyl group precursor functional group; and Y independently represent a halogen atom or an alkoxy group having 1-4 carbon atoms; and converting the hydroxyl group precursor functional group represented by X to a hydroxyl group.

### BACKGROUND OF THE INVENTION

1. Field of the Invention

The present invention relates to analysis technology involved in gene sequences in analyses of biologically functional molecules, particularly DNA sequences and in genetic diagnosis, and a method for manufacturing a substrate for making a device for analysis used for those analyses.

2. Description of the Related Art

Analysis of DNA sequences of genes represented by the analysis of human genome has undergone a rapid progress recently, and the information obtained by such analyses has been applied vigorously to the investigation of the functions of genes, and diagnosis of gene-mediated diseases. In parallel with this tendency, many researches have been performed on so-called DNA chips or DNA microarrays, because those chips are a powerful tool for the technique which allows the rapid and large-scale analysis of genes or study of the functions of genes.

The DNA microarray is an element wherein each of DNA molecules having specified sequences is immobilized on a tiny space so that a DNA strand in a sample having a sequence complimentary to a specified sequence can be detected. CHEMTECH, February 1997, pp. 22 proposes a method for manufacturing a DNA array based on photolithography conventionally used for the fabrication of semiconductors, wherein the site-selective synthesis of DNA sequences is carried out through a process of multiple steps so that a microarray modified by a variety of DNA molecules can be prepared after a surprisingly small number of processes. This document suggests the possibility of preparing a microarray that will allow one to examine one billion or more different kinds of DNA sequences at one time by repeating the 15-time hybridization of different nucleotides site-selectively and systematically.

On the other hand, if it were possible to electrically detect a DNA strand complimentary to a specified sequence as described above, it would be possible to analyze DNA sequences by a rapid and simple method. A number of attempts have been made for producing semiconductor apparatuses allowing for the electric detection of a DNA strand and as such known attempts, can be mentioned Domestic Re-publication of WO2003/087798 and Japanese Patent Laid-open (Kokai) No. 2005-77210. In these semiconductor apparatuses, the presence or absence of the complementary DNA strand is detected on a microchip as a practical application of a sensor by a field effect transistor known conventionally.

Incidentally, in order to prepare a DNA microarray enabling the rapid and large-scale analysis, it is necessary to immobilize DNA strands onto the tiny space of a microarray substrate site-selectively so securely that no such problems as detachment and the like can never arise. In order to analyze the biologically functional molecules including DNA molecules, as the method for two-dimensionally immobilizing them on a metal, the method of using specific absorption of a sulfur atom on a gold surface is known and described in, for example, Domestic Re-publication of WO2003/087798. Alternatively, there has been a method known for a considerably long period of time that consists of forming a monomolecular film on the surface of a substrate using silicon oxide chains, and immobilizing enzymes to the alkyl chains extending from silicon atoms in such a manner as to allow the enzymes to be immobilized to the semiconductor so securely that the risk of the molecules thus immobilized of being subject to detachment can be minimized, and Japanese Patent Laid-open (Kokai) No. 62-50657 discloses one such method. The above-mentioned Japanese Patent Laid-open (Kokai) No. 2005-77210 also mentions this method can be applied to the method it deals with.

When it is desired to prepare a high-performance microarray, it will be necessary to achieve the site-selective immobilization of a material utilizing microlithography as indicated in CHEMTECH, February 1997, pp. 22. However, as discussed in CHEMTECH, February 1997, pp. 22, in order to make fine-processing, it is necessary to avoid the detachment of a resist film from a substrate, and CHEMTECH, February 1997, pp. 22 solves this problem by forming an underlying resist film at a separate process. However, introduction of a separate process for the formation of an underlying resist film will increase necessary processes and complicate the overall process.

The same applies to the method shown in Science 251, 767-773 (1991). According to the method, prior to the immobilization of DNA molecules, amino acids are arranged on the surface of a substrate, then a substance acting as a linker is chemically attached to the amino acids, and target DNA molecules or oligonucleotides are allowed to extend. However, according to this method, the distance between a field effect transistor on the substrate and the oligonucleotide serving as a probe becomes so great as to affect the sensitivity of the array.

Thus, there has been a need for a method for manufacturing a substrate for microarray that allows for the high precision processing using a chemically amplified type resist being simply relieved of the problems such as the detachment of the resist film from the substrate.

### SUMMARY OF THE INVENTION

With the above-mentioned circumstance, the present invention was accomplished, and aims to provide a method for manufacturing a substrate for microarray which, when a target molecule is immobilized onto a substrate by means of a monomolecular film comprising silicon chains, will allow high-precision processing; even when a chemically amplified type resist is directly applied to a substrate in order to simplify the overall process, will be relieved of the problems such as the degraded resolution and detachment; and will allow the readier preparation of a substrate for the immobilization of a material by the use of more simplified processes than are possible with the conventional method.

The present invention is provided as a solution to the above-mentioned problems, and relates to a method for manufacturing a substrate for microarray. The method comprises at least the steps of: forming a monomolecular film on the surface of a substrate using a silane compound represented by the following general formula (1),

Y₃Si—(CH₂)ₘ—X (1)
, wherein m represents an integer from 3 to 20; X represents a hydroxyl group precursor functional group; and Y independently represent a halogen atom or an alkoxy group having 1-4 carbon atoms; and converting the hydroxyl group precursor functional group represented by X to a hydroxyl group.

As seen from above, simple execution of the above-mentioned two steps will make it possible to form, on the surface of a substrate, a monomolecular layer having a hydroxyl group necessary for the immobilization of a target molecule. The monomolecular layer, owing to the hydroxyl group, will have a certain degree of polarity which will prevent the occurrence of problems such as the detachment of a resist film. Moreover, since the functional group of the monomolecular film is hydroxyl group, the problems such as the degraded resolution and detachment which may result from the reaction of the functional group with acid will be safely avoided. Therefore, it is possible by using a chemically amplified type resist to achieve a finer processing more precisely than is possible with the conventional method.

The step of converting the hydroxyl group precursor functional group to a hydroxyl group may be preferably achieved by treating the hydroxyl group precursor functional group with acid to convert it to a hydroxyl group.

When converting it to a hydroxyl group by acid treatment, more suitable pattern formation can be obtained by using a chemically amplified type resist directly on the obtained substrate.

The hydroxyl group precursor functional group represented by X in the general formula (1) may be an alkoxymethoxy group in which the alkoxy group moiety has 1-6 carbon atoms and/or an oxyranyl group.

Suitable examples of the hydroxyl group precursor functional group represented by X may include an alcoxymethoxy group in which the alkoxy group moiety has 1-6 carbon atoms and/or an oxyranyl group.

With regard to the step of forming a monomolecular film using a silane compound represented by the general formula (1), it is preferred to mix the silane compound with at least one of silane compounds represented by the following general formulae (2) and (3),

Y′₃Si—(CH₂)ₙ—CH₃ (2)

Y′₃Si—(CH₂)ₙ—OCH₃, (3)

wherein n is an integer from 0 to (m-2), m is as defined in relation to the general formula (1); and Y′ represent a halogen atom or an alkoxy group having 1-4 carbon atoms; and use the resulting mixture to form the monomolecular film.

When at least one compound or more selected from the compounds represented by the general formulae (2) and (3) is combined with a silane compound represented by the general formula (1) into a mixture and the mixture is used for the formation of a monomolecular film, it is possible to dispose hydroxyl groups which are necessary for the immobilization of a material outwards from the average surface of the monomolecular film, and thus to ensure a space around each site sufficiently wide for the immobilization of a material. Through this arrangement it is possible to securely execute the immobilization operation, to ensure a blank space around a material immobilized to the site and to securely detect, during the actual practice of analysis, the presence of a test sample if any by virtue of the material immobilized to the site.

Furthermore, it is preferred to combine a compound represented by the general formula (3) with a compound represented by the general formula (2) into a mixture, and to use the mixture, because then it is possible to add the mixture to a silane compound represented by the general formula (1) for mixture without being accompanied by the increase of contact angle. This is particularly advantageous for the case where simply a resist is coated after the formation of a monomolecular film because in that case the increase of contact angle will be undesirable.

The microarray can be used for analyses of biomolecules.

This way, the microarray can be used in tests involving the sequencing of genes including the analysis of biologically functional molecules, particularly of DNA sequences, and genetic diagnosis.

As described above, it is possible by using the method for manufacturing a substrate for microarray of the present invention to readily obtain a substrate for microarray in a simplified manner while being protected against the problems such as the detachment of a material immobilized to the substrate, keeping the distance between the probe and the substrate short, and allowing the fine and precise processing of the substrate by the use of a chemically amplified type resist.

### BRIEF DESCRIPTION OF THE DRAWINGS

FIG. 1 is a diagram for outlining an embodiment of a method for manufacturing a substrate for microarray according to the present invention.

### REFERENCE NUMERALS

1a: Substrate
1b: Resist film
2c: Patterned mask
2d: Excimer laser beam
4e: Solution for the formation of a monomolecular film
5f: Monomolecular film
6g: Acid solution
6f: Monomolecular film
7b: Resist film
7h: Monomolecular film having hydroxyl group
8a: Substrate for the manufacture of microarray
8h: Monomolecular film

### DESCRIPTION OF THE INVENTION AND A PREFERRED EMBODIMENT

The present invention will be described below with reference to embodiments, but it should be understood that the present invention is not limited to those embodiments.

In order to ensure the secure adhesion of a resist film, the site on a substrate upon which a DNA molecule will be immobilized must have a certain degree of polarity. In addition, when a chemically amplified type resist is used during processing, it will be desirable to make the surface of the substrate free of functional groups such as amino groups which will capture hydrogen ions. In view of this, the present inventors had thought hydroxyl group would be suitable as a functional group of the spacer.

However, when a method using hydroxyl group as a functional group of the spacer is employed, a plurality of processes will be required for the acquisition of hydroxyl group as is noted in Japanese Patent Laid-open (Kokai) No. 2005-77210, and the distribution of the functional group may be skewed depending on the position of sites.

As a consequence of many attempts, the present inventors found that a monomolecular film comprising silicon oxide chains having, as a functional group, a hydroxyl precursor allows the hydroxyl precursor to be securely converted to a hydroxyl group after a single step reaction, and the employment of this film will solve the above-mentioned problem. This finding led to the present invention.

The present invention provides a method for manufacturing a substrate for microarray comprising at least the steps of: forming a monomolecular film on the surface of a substrate using a silane compound represented by the following general formula (1),

Y₃Si—(CH₂)ₘ—X, (1)

wherein m represents an integer from 3 to 20; X represents a hydroxyl group precursor functional group which will be converted to a hydroxyl group when exposed to acid; and Y independently represent a halogen atom or an alkoxy group having 1-4 carbon atoms; and converting the hydroxyl group precursor functional group represented by X to a hydroxyl group.

The microarray prepared according to the method for manufacturing a substrate for microarray of the present invention is not limited, with regard to its data acquisition methodology, to any particular method including a fluorescence-based method, electricity-based method, or the like, but when the method of the present invention is employed on a semiconductor apparatus during the preparation of a substrate for microarray, it is particularly preferred.

When the substrate of the present invention is used in combination with a semiconductor apparatus for executing an electricity-based method for analysis, the substrate may be used in accordance with any known electricity-based method including the one indicated in Domestic Re-publication of WO2003/087798 where the substrate is immobilized over a capacitor, and the one indicated in Japanese Patent Laid-open (Kokai) No. 2005-77210 where the substrate is immobilized over the surface of a gate electrode, or floating electrode connected to a gate electrode.

In the practice of the method of the present invention, when the top surface of a substrate material responsible for the immobilization is constituted of a metal oxide film, it is possible to form a monomolecular film having silicon oxide chains on the substrate by directly treating the top surface with a silicon compound as described later, since the metal oxide contains a sufficient amount of hydroxyl group. Alternatively, when the top surface of a substrate is constituted of a metal film, a superficial oxide layer naturally forming on the metal film may be used, or only the superficial layer of the metal film may be deliberately oxidized by exposing it to ozone, aqueous solution of hydrogen peroxide, water, or oxygen plasma, etc. When detection is achieved by a method not dependent on electricity, the monomolecular film may be formed on a resin substrate. In such a case, according to the disclosure given by Japanese Patent Laid-open (Kokai) No. 4-221630, it is possible to form a monomolecular film comprising silicon oxide chains by exposing the surface of the substrate to an electron or ion beam in an oxygen atmosphere.

The monomolecular film may be formed over the entire surface of a substrate. However, generally, the monomolecular film may be formed on desired spots over the surface of a substrate. This may be achieved by using a resist film so that spots carrying a monomolecular film are formed site-selectively over the substrate. The operation for this has been known well in the art, and the suitable resist film is not limited to any known specific one, but it is preferred to use a chemically amplified type resist because such a resist may allow a monomolecular film to be formed on tiny spots precisely in a site-selective manner.

As the chemically amplified resist used here, it is preferable that the monomolecular film is not formed on the resist film in the step of forming the monomolecular film. It is preferable that the resin used for the resist composition contains 5 mole % or less polymerization unit containing hydroxyl group. It is more preferable that the unit having the hydroxyl group is not contained. Thus, also in this sense, it is preferable to select the chemically amplified positive resist rather than a novolak based resist where the presence of the hydroxyl group is essential on its mechanism or a negative type resist where solubility is changed by crosslinking based on the hydroxyl group, as the type of the resist.

A preferred resin suitably used for the construction of a positive resist which does not require the introduction of hydroxyl group for its polymerization mechanism in contrary to the polymers as mentioned above, is a polymer obtained by combining a unit having an acid functional group protected by an acid degradable protecting group with a so-called adhesive group developed for the combined use of an ArF excimer laser.

The unit having an acid functional group protected with an acid degradable protecting group may include a tertiary alkyl group, tertiary alkoxycarbonyl group, or a unit having a phenolic hydroxyl group protected with acetal group, more specifically protected vinylphenol, similarly protected carboxyl group, more specifically protected vinyl benzoate, (metha)acrylate, etc. Many of them have been known in the prior art (see, for example, Japanese Patent Laid-open (Kokai) No. 2006-225476 and Japanese Patent Laid-open (Kokai) No. 2006-328259).

The so-called adhesive group which has been developed for the use in combination with an ArF excimer laser may include units which include a cyclic ether structure or lactone structure. Particularly, those that have a lactone structure is notably effective, and many of them have been known in the prior art (see, for example, Japanese Patent Laid-open (Kokai) No. 2006-328259).

With regard to the polymerization ratio of the two units described above, when the unit having an acid functional group protected with an acid degradable protecting group is used at 20 mole % or more, the resulting film will be nearly relieved of the risk of degrading the resolution. On the other hand, when the unit having an adhesive group is used at 20 mole % or more, the resulting film will be nearly relieved of the risk of being dissociated from the substrate.

To a composition for the formation of a resist film, may be added as needed a basic substance, a surfactant and the like, and many of such additives have been known in the prior art (see, for example, Japanese Patent Laid-open (Kokai) No. 2006-225476 and Japanese Patent Laid-open (Kokai) No. 2006-328259), and basically any of them may be used. Further, methods for the formation of a resist pattern have been known in the prior art, and it is possible to use any of those methods such that only desired portions can be masked.

Next, the step of forming a monomolecular film will be described.

The step of forming a monomolecular film having silicon oxide chains comprises treating an uncoated substrate, that is, when the substrate has a resist pattern formed on its surface for protecting the portions other than spots where a detection material will be immobilized, the surface of those spots, and when the substrate having no resist pattern formed thereon so that a detection material can be immobilized on the entire surface, the entire surface, with a solution containing a silane compound represented by the following general formula (1),

Y₃Si—(CH₂)ₘ—X, (1)

wherein m represents an integer from 3 to 20; X represents a hydroxyl group precursor functional group which will be converted to a hydroxyl group when exposed to acid; and Y independently represent a halogen atom or an alkoxy group having 1-4 carbon atoms; and forming thereby a monomolecular film on the substrate.

When m of the general formula (1) is 3 or more, the resulting compound will be satisfactory, as far as the formation of a monomolecular film is concerned. However, as will be described later, when it is required to precisely define spots where detection materials will be immobilized, the compound where m is equal to or larger than 5, or more preferably m is equal to or larger than 8 should be used.

The hydroxyl group precursor functional group X is a hydroxyl group protected with a so-called protecting group, or a vicinal diol. Many such protective groups have been known in the art, and representative ones may include an acyl group, an oxyranyl group, an acetal group, and the like. In order for the detection materials to be immobilized only to specified spots of a monomolecular film at a later step, it is necessary to mask the spots of a monomolecular film using a resist. When a chemically amplified type resist is used in this case, the monomolecular film is preferably protected against the contamination from basic substances, and is preferably made of a protected compound whose protection can be removed when treated with acid. As such protected compounds whose protection will be removed when exposed to acid may be mentioned, among the compounds cited above, an oxyranyl group and an acetal group. More specifically, it includes an alcoxymethoxy group in which the alkoxy group moiety has 1-6 carbon atoms and/or an oxyranyl group. Among the acetal groups, when X′ is a methoxymethoxy group or an oxyranyl group, the monomolecular film is easily formed because the groups are sterically small.

The hydroxyl group which serves as a functional group responsible for the immobilization of a detection material should have a sufficient space around it as easily expected from its function. To introduce such an environment, it is preferred to mix a silane compound represented by the general formula (1) with at least one of silane compounds having shorter chains and represented by the following general formulae (2) and (3),

Y′₃Si—(CH₂)ₙ—CH₃ (2)

Y′₃Si—(CH₂)ₙ—OCH₃, (3)

wherein n is an integer from 0 to (m-2), m is as defined in relation to the general formula (1); and Y′ represents a halogen atom or an alkoxy group having 1-4 carbon atoms; and use the resulting mixture.

The compound(s) represented by the general formula (2) and/or (3) may be added by 1 mole times or more, or more preferably 4 mole times or more than the silane compound represented by the general formula (1). To ensure the immobilization of a sufficient amount of a detection material, however, the former compound is preferably added at 200 mole times or less, more preferably 100 mole times or less.

Formation of a monomolecular film using a silane compound having silicon oxide chains may be achieved by a method as disclosed in Japanese Patent Laid-open (Kokai) No. 62-50657. Namely, formation of a monomolecular film may be achieved by employing, for example, a solvent having a very low polarity, adding the solvent to the silane compound represented by the general formula (1) or the silane compounds represented by the general formula (2) to give a comparatively dilute solution where the mixture is present at 2.0×10⁻² to 5.0×10⁻² mole/l. Then, a coated substrate where portions of its surface which should reject the formation of a film have been protected with a resist, is immersed in the solution. For example, when trichlorosilane is used as the solvent, the preferred immersion time will be 2 to 3 minutes, while when trimethoxysilane is used, the time in question will be 2 hours.

Subsequent to the above-mentioned treatment, it is possible by subjecting the hydroxyl precursor X to deprotection treatment to obtain a substrate for microarray whose surface is coated with a monomolecular film comprising silicon oxide chains having hydroxyl group as a functional group responsible for the immobilization. The deprotection treatment may occur by any known method suitable for the protecting group used. For example, when an oxyranyl group or an acetal group is used, it will be possible to remove the group by treating the substrate in an acidic environment containing water to expose a hydroxyl group.

Subsequent to the above-mentioned treatment, it is possible by treating the substrate with an organic solvent generally used for dissolving a resist film, for example, a solvent generally used for preparing a resist solution such as propyleneglycolmonoethylether, ethyl lactate, etc., to remove the substrate of the resist pattern, and then the preparation of a substrate for microarray is completed. Because the substrate obtained as above contains a rich amount of hydroxyl group having a polarity on its surface, it will securely bind to the resist film even when the resist film is of positive type and is directly applied. Moreover, it will be possible to alter the immobilization method, for example, hydroxyl group at one end of nucleotide may be further converted to formyl group as needed by using periodic acid.

### EXAMPLES

The present invention will be illustrated below with reference to examples, but it should be understood that the present invention is not limited to those examples.

### Production Example 1

### Production of 10-(methoxymethoxy)decyltrimethoxysilane

Under a nitrogen atmosphere, 64 g of trimethoxysilane and 0.57 g of acetic acid were dropped in a mixture of 100 g of 10-(methoxymethoxy)-1-decene and a catalytic amount of a solution of palatinate chloride in tetrahydrofuran at 80° C. The reaction mixture was stirred at 80° C. for 3 hours, and distilled under reduced pressure to yield 131 g of a target compound.

10-(Methoxymethoxy)decyltrimethoxysilane

Boiling point: 142° C./66 Pa

IR(liquid film) νmax: 2927, 2854, 2840, 1465, 1191, 1143, 1089, 1049 cm⁻¹

¹³C-NMR (150 MHz, CDCl₃) δ: 9.10, 22.55, 26.18, 29.19, 29.39, 29.56, 29.71, 33.09, 50.44, 55.03, 67.84, 96.34 ppm

¹H-NMR (600 MHz, CDCl₃) δ: 0.59-0.62 (2H, m), 1.21-1.39 (14H, m), 1.52-1.57 (2H, quintet-like), 3.32 (3H, s), 3.48 (2H, t, J=7 Hz), 3.53 (9H, s), 4.58 (2H, s) ppm.

### Production Example 2

### Production of 11,12-epoxydodecyltrimethoxysilane

It was produced according to the method described in Japanese Patent Laid-open (Kokai) No. 4-182491.

11,12-Epoxydodecyltrimethoxysilane

IR(liquid film) νmax: 3041, 2925, 2854, 2840, 1727, 1465, 1911, 1089, 916 cm⁻¹.

¹³C-NMR (150 MHz, CDCl₃) δ: 9.10, 22.54, 25.92, 29.18, 29.39, 29.40, 29.42, 29.48, 32.45, 33.08, 47.07, 50.42, 52.35 ppm.

¹H-NMR (600 MHz, CDCl₃) δ: 0.59-0.62 (2H, m), 1.20-1.51 (20H, m), 2.421 (1H, dd, J=3.5 Hz), 2.70 (1H, t-like, J=5 Hz), 2.85-2.88 (1H, m) ppm.

### Production Example 3

### Production of a Polymer for Resist

t-Butoxystylene:1-ethylcyclopentylmethacrylate:β-methacryloyloxy-γ-butyllactone=30:10:60

A 17.6 g of t-butoxystylene, 18.2 g of 1-ethylcyclopentylmethacrylate, and 17.0 g of β-methacryloyloxy-γ-butyllactone were dissolved to 1100 g of methylisobutylketone, to which was added 1.3 g of AIBN, and the mixture was heated at 80° C. for 8 hours. The resulting mixture was poured into a bulk of hexane to precipitate. The precipitate was dissolved in a small amount of methylisobutylketone, which was then precipitated through its renewed immersion in a bulk of hexane. Through these procedures was obtained a copolymer having a composition as described above that has a weight-average molecular weight of about 8000 and dispersive power of 2.0.

### Production Example 4

### Preparation of a Resist Composition

A mixture comprising (t-butoxystylene:1-ethylcyclopentylmethacrylate:β-methacryloyloxy-γ-butyllactone=30:10:60) 80 parts by mass, triphenylsulfonium p-toluenesulfonate 6 parts by mass, and tributylamine 0.5 part by mass was dissolved in PGMEA 720 parts by mass, and the mixture was filtered to give a solution which was used as a resist composition.

### Example 1

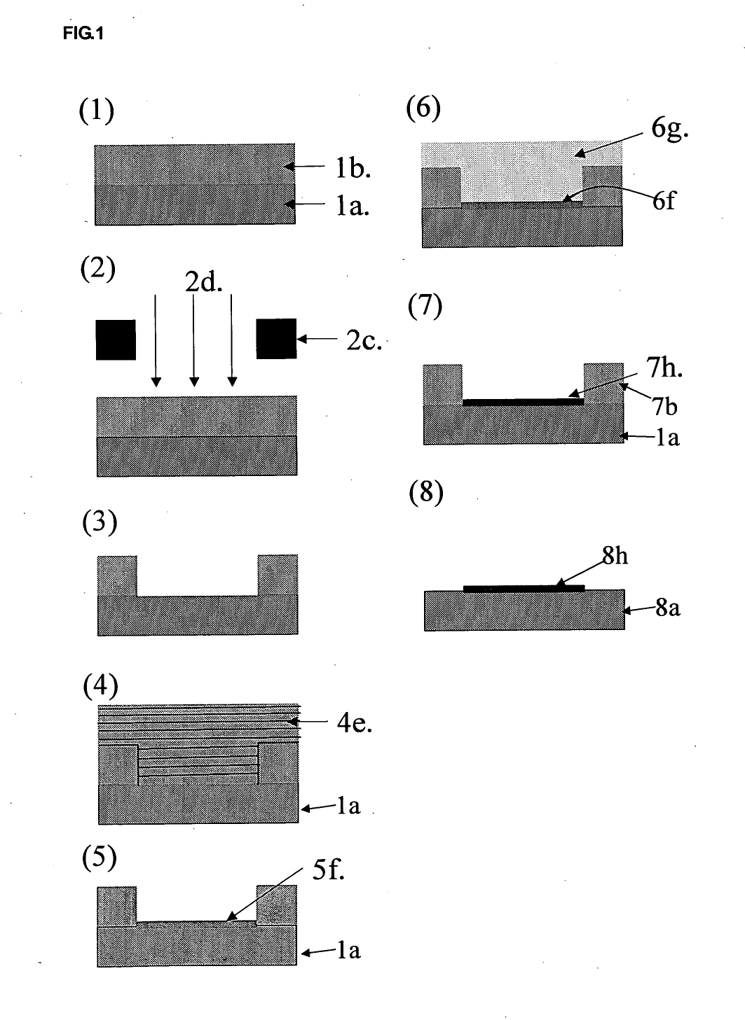

Onto a substrate 1a to be processed, a solution of the resist composition prepared as in Production Example 4 was coated by spin-coating, and heated at 100° C. for 90 sec for pre-baking, to form a resist film 1b 0.3 μm thick on the substrate (FIG. 1(1)).

Then, a KrF excimer laser 2d was radiated through a mask pattern 2c onto the resist film 1b so that specified spots of the film upon which a monomolecular film will be formed can be irradiated with the beam (FIG. 1 (2)). After the exposure, the substrate was heated at 110° C. for 90 sec for post-baking. Then, a 2.38% TMAH aqueous solution was applied for developing and thus a resist pattern was obtained that consisted of apertures formed at the specified spots upon which a monomolecular film will be formed (FIG. 1(3)).

Next, 2.1 g of 10-(methoxymethoxy)decyltrimethoxysilane obtained as in Production Example 1, and 5.9 g of hexyltrimethoxysilane were dissolved in 4% dichloromethane-hexane to 1 liter, to give a solution for the formation of a monomolecular film. In this solution 4e for the formation of a monomolecular film was immersed the substrate 1a for 2 hours (FIG. 1(4)), to form a monomolecular film 5f (FIG. 1(5)).

The substrate 1a having received the immersion treatment was treated by 6g of a methanol solution obtained by adding conc. hydrochloride to methanol to 0.8 wt. %, at 60° C. for 30 minutes (FIG. 1(6)), so that the methoxymethoxy group of monomolecular layer 6f can be deprotected, and thus a monomolecular film 7h with hydroxyl group obtained (FIG. 1(7)).

In addition, the substrate 1a treated as above was immersed in propyleneglycol monomethylether to remove the resist film 7b. As a result, a substrate 8a for making microarray was obtained that has, at each position specified for the immobilization of a recognition material, a monomolecular film 8h formed which has silicon oxide chains possessing hydroxyl group as a functional group for the immobilization (FIG. 1(8)).

### Example 2

A patterned resist film was obtained as in Example 1 that had apertures at sites where a monomolecular film will be formed.

Then, 2.0 g of 11,12-epoxydodecyltrimethoxysilane obtained as in Production Example 2, and 5.9 g of octyltrimethoxysilane were dissolved in 4% dichloromethane-hexane to 1 liter to give a material solution for the formation of a monomolecular film. In this material solution for the formation of a monomolecular film was immersed the substrate having the patterned resist film formed thereon for 2 hours to allow a monomolecular film to be formed.

The substrate having received the immersion treatment was treated at 60° C. for 30 minutes with a methanol solution obtained by adding conc. hydrochloride to ethanol to 0.8 wt. %, so that the oxyranyl group of monomolecular layer can be deprotected, and hydroxyl group obtained instead.

The substrate treated as described above was further immersed in propyleneglycol monoethylether to remove the resist film. Thus, a substrate for microarray was obtained that has, at each spot specified for the immobilization of a recognition material, a monomolecular film formed which has hydroxyl group as a functional group for the immobilization.

### Example 3

A silicon wafer was washed by exposing it to ultrasonic waves in acetone for 30 minutes. Next, 10-(methoxymethoxy)decyltrimethoxysilane (silane compound 1) obtained as in Production Example 1, octyltrimethoxysilane (silane compound 2) and 10-methoxydecyltrimethoxysilane (silane compound 3) were combined at the ratios as indicated in Table 1, and the mixture was added to 0.03 M 4% dichloromethane-hexane to 1 liter.

TABLE 1

| | Silane | Silane | Silane |
|---|---|---|---|
| | compound 1 | compound 2 | compound 3 |
| Reaction solution 1 | 100% | 0% | 0% |
| Reaction solution 2 | 92% | 0% | 8% |
| Reaction solution 3 | 92% | 4% | 4% |
| Reaction solution 4 | 92% | 8% | 0% |
| Reaction solution 5 | 75% | 0% | 25% |
| Reaction solution 6 | 75% | 12.5% | 12.5% |
| Reaction solution 7 | 75% | 25% | 0% |
| Reaction solution 8 | 50% | 0% | 50% |
| Reaction solution 9 | 50% | 25% | 25% |
| Reaction solution 10 | 50% | 50% | 0% |
| Reaction solution 11 | 25% | 0% | 75% |
| Reaction solution 12 | 25% | 36.5% | 36.5% |
| Reaction solution 13 | 25% | 75% | 0% |

Each of the reaction solutions was used to form a monomolecular film on the silicon wafer. The monomolecular film was subjected to the water-based contact angle measurement, and evaluated for its affinity to the coating of resist obtained as in Production Example 4. The results are shown in Table 2.

TABLE 2

| | Surface | Affinity to |
|---|---|---|
| | contact | resist |
| | angle | coating |
| Reaction solution 1 | 73° | ∘ |
| Reaction solution 2 | 75° | ∘ |
| Reaction solution 3 | 75° | ∘ |
| Reaction solution 4 | 74° | ∘ |
| Reaction solution 5 | 80° | ∘ |
| Reaction solution 6 | 76° | ∘ |
| Reaction solution 7 | 75° | ∘ |
| Reaction solution 8 | 87° | Δ |
| Reaction solution 9 | 80° | ∘ |
| Reaction solution 10 | 76° | ∘ |
| Reaction solution 11 | 95° | x |
| Reaction solution 12 | 83° | ∘ |
| Reaction solution 13 | 77° | ∘ |

With regard to the results shown in Table 2 indicating the affinity to resist coating, ∘, Δ, and x represent the absence of striation (∘), occasional striation (Δ), and continual presence of striation (x) observed during spin-coating, respectively.

From these results it was confirmed that it is possible according to the invention to control the surface contact angle, and the formation of a polymer layer during the post-modification of a monomolecular film.

Substrates for microarray were prepared as in Examples 1, 2, and 3 above, and a chemically amplified type resist film is directly applied onto the substrate so that a target molecule can be securely immobilized thereon. The substrate was found to be free from the problems such as the degradation of resolution and detachment, and allows the fine processing at a high precision.

The present invention is not limited to the above-described embodiments. The above-described embodiments are some examples, and those having the substantially same composition as that described in the appended claims and providing the similar effects are included in the scope of the present invention.

1. A method for manufacturing a substrate for microarray comprising at least the steps of: forming a monomolecular film on the surface of a substrate using a silane compound represented by the following general formula (1),
Y₃Si—(CH₂)ₘ—X (1)
wherein m represents an integer from 3 to 20; X represents a hydroxyl group precursor functional group; and Y independently represent a halogen atom or an alkoxy group having 1-4 carbon atoms; and
converting the hydroxyl group precursor functional group represented by X to a hydroxyl group.

2. The method for manufacturing a substrate for microarray according to claim 1, wherein the step of converting the hydroxyl group precursor functional group to a hydroxyl group comprises treating the hydroxyl group precursor functional group with acid to convert it to a hydroxyl group.

3. The method for manufacturing a substrate for microarray according to claim 2, wherein the hydroxyl group precursor functional group represented by X in the general formula (1) is an alkoxymethoxy group in which the alkoxy group moiety has 1-6 carbon atoms and/or an oxyranyl group.

4. The method for manufacturing a substrate for microarray according to claim 1, wherein the step of forming a monomolecular film using a silane compound represented by the general formula (1) comprises mixing the silane compound with at least one of silane compounds represented by the following general formulae (2) and (3),
Y′₃Si—(CH₂)ₙ—CH₃ (2)
Y′₃Si—(CH₂)ₙ—OCH₃, (3)
wherein n is an integer from 0 to (m-2), m is as defined in relation to the general formula (1); and Y′ represents a halogen atom or an alkoxy group having 1-4 carbon atoms; and
using the resulting mixture to form the monomolecular film.

5. The method for manufacturing a substrate for microarray according to claim 2, wherein the step of forming a monomolecular film using a silane compound represented by the general formula (1) comprises mixing the silane compound with at least one of silane compounds represented by the following general formulae (2) and (3),
Y′₃Si—(CH₂)ₙ—CH₃ (2)
Y′₃Si—(CH₂)ₙ—OCH₃, (3)
wherein n is an integer from 0 to (m-2), m is as defined in relation to the general formula (1); and Y′ represents a halogen atom or an alkoxy group having 1-4 carbon atoms; and
using the resulting mixture to form the monomolecular film.

6. The method for manufacturing a substrate for microarray according to claim 3, wherein the step of forming a monomolecular film using a silane compound represented by the general formula (1) comprises mixing the silane compound with at least one of silane compounds represented by the following general formulae (2) and (3),
Y′₃Si—(CH₂)ₙ—CH₃ (2)
Y′₃Si—(CH₂)ₙ—OCH₃, (3)
wherein n is an integer from 0 to (m-2), m is as defined in relation to the general formula (1); and Y′ represents a halogen atom or an alkoxy group having 1-4 carbon atoms; and
using the resulting mixture to form the monomolecular film.

7. The method for manufacturing a substrate for microarray according to claim 1, wherein the microarray is used for analyses of biomolecules.

8. The method for manufacturing a substrate for microarray according to claim 2, wherein the microarray is used for analyses of biomolecules.

9. The method for manufacturing a substrate for microarray according to claim 3, wherein the microarray is used for analyses of biomolecules.

10. The method for manufacturing a substrate for microarray according to claim 4, wherein the microarray is used for analyses of biomolecules.

11. The method for manufacturing a substrate for microarray according to claim 5, wherein the microarray is used for analyses of biomolecules.

12. The method for manufacturing a substrate for microarray according to claim 6, wherein the microarray is used for analyses of biomolecules.
